(19) United States
(12) Patent Application Publication
(10) Pub. No.: US 2023/0343090 A1
(43) Pub. Date: Oct. 26, 2023

(54) Automated Treatment of an Agricultural Field

(71) Applicant: Centure Applications LTD, Tel-Aviv (IL)

(72) Inventors: Itzhak Khait, Kibutz Ein Zivan (IL); Alon Klein Orbach, Tel-Aviv (IL)

(21) Appl. No.: 18/028,028

(22) PCT Filed: Sep. 17, 2021
(86) PCT No.: PCT/IL2021/051133

§ 371 Date: Mar. 23, 2023

Related U.S. Application Data
(60) Provisional application No. 63/082,500, filed on Sep. 24, 2020.

(51) Int. Cl. G06V 20/10; G06T 7/73; G06V 20/56; A01M 7/00; A01C 23/00

(52) U.S. Cl. CPC G06V 20/188; G06T 7/74; G06V 20/56; A01M 7/0089; A01C 23/007; G06T 2207/30188

(57) ABSTRACT

There is provided a system for dynamic adaptation of a treatment applied to an agricultural field growing crops, comprising: a processor executing a code for: receiving a first and a second image from a first and a second imaging sensor, the first and second imaging sensors are located on an agricultural machine having a treatment application element(s) that applies the treatment to the agricultural field, the first and second image depict a portion of the agricultural field and overlap at an overlap region, analyzing the overlap region to compute a dynamic orientation parameter(s) of the agricultural machine, and generating instructions, according to the dynamic orientation parameter(s), for execution by a hardware component(s) associated with the agricultural machine for dynamic adaptation of the treatment applied by the treatment application element(s) to the portion of the agricultural field depicted in the first and second images to obtain a target treatment profile.

### RELATED APPLICATIONS

The present application is a national phase entry of PCT Application No. PCT/IL2021/051133 filed on Sep. 17, 2021, which claims the benefit and priority of U.S. Provisional Application Ser. No. 63/082,500 filed on Sep. 24, 2020, all of which are incorporated herein by reference in their entirety.

### TECHNICAL FIELD AND BACKGROUND

The present invention, in some embodiments thereof, relates to agricultural treatment of plants, more specifically, but not exclusively, to systems and methods for real-time dynamic adjustment of treatment of plants.

Agricultural machines are used to treat agricultural fields, for example, to apply pesticides, herbicides, and fertilizers. The treatment may be applied by a spray boom, which may be carried by agricultural machine, such a tractor and/or connected to an airplane. Spray booms may be very large, for example, ranging in length from about 10 meters to 50 meters.

### SUMMARY

According to a first aspect, a system for dynamic adaptation of a treatment applied to an agricultural field growing crops, comprises: at least one hardware processor executing a code for: receiving a first image from a first imaging sensor and a second image from a second imaging sensor, wherein the first imaging sensor and the second imaging sensor are located on an agricultural machine having at least one treatment application element that applies the treatment to the agricultural field, wherein the first image and the second image depict a portion of the agricultural field and overlap at an overlap region, analyzing the overlap region to compute at least one dynamic orientation parameter of the agricultural machine, and generating instructions, according to the at least one dynamic orientation parameter, for execution by at least one hardware component associated with the agricultural machine for dynamic adaptation of the treatment applied by the at least one treatment application element to the portion of the agricultural field depicted in the first and second images to obtain a target treatment profile.

According to a second aspect, a computer implemented method of dynamic adaptation of a treatment applied to an agricultural field, comprises: receiving a first image from a first imaging sensor and a second image from a second imaging sensor, wherein the first imaging sensor and the second imaging sensor are located on an agricultural machine having at least one treatment application element that applies the treatment to the agricultural field, wherein the first image and the second image depict a portion of the agricultural field and overlap at an overlap region, analyzing the overlap region to compute at least one dynamic orientation parameter of the agricultural machine, and generating instructions, according to the at least one dynamic orientation parameter, for execution by at least one hardware component associated with the agricultural machine for dynamic adaptation of the treatment applied by the at least one treatment application element to the portion of the agricultural field depicted in the first and second images to obtain a target treatment profile.

According to a third aspect, a computer program product for dynamic adaptation of a treatment applied to an agricultural field comprising program instructions which, when executed by a processor, cause the processor to perform: receiving a first image from a first imaging sensor and a second image from a second imaging sensor, wherein the first imaging sensor and the second imaging sensor are located on an agricultural machine having at least one treatment application element that applies the treatment to the agricultural field, wherein the first image and the second image depict a portion of the agricultural field and overlap at an overlap region, analyzing the overlap region to compute at least one dynamic orientation parameter of the agricultural machine, and generating instructions, according to the at least one dynamic orientation parameter, for execution by at least one hardware component associated with the agricultural machine for dynamic adaptation of the treatment applied by the at least one treatment application element to the portion of the agricultural field depicted in the first and second images to obtain a target treatment profile.

In a further implementation form of the first, second, and third aspects, further comprising code for: capturing at least one analysis image depicting a structure of a portion of the agricultural field by the first imaging sensor and/or the second imaging sensor, analyzing the at least one analysis image to determine the structure depicted therein, and wherein generating instructions, comprises generating instructions according to the at least one dynamic orientation parameter and the structure depicted therein, for adapting at least one hardware component associated with the agricultural machine for dynamic adaptation of the treatment applied by the at least one treatment application element to the structure depicted in the at least one analysis image to obtain the target treatment profile.

In a further implementation form of the first, second, and third aspects, the structure determined by the analysis of the at least one analysis image is selected from a group consisting of: presence or absence of the structure in the image, location of the structure in the image, agricultural crop, type of crop, undesired plants, weeds, stage of growth, crop diseased, presence of insects on crop, crop lacking water, crop receiving sufficient water, crop lacking fertilizer, crop having sufficient fertilizer, healthy, sufficient growth, and insufficient growth.

In a further implementation form of the first, second, and third aspects, further comprising code for scheduling the capture of the at least one analysis image according to the computed at least one dynamic orientation parameter.

In a further implementation form of the first, second, and third aspects, the at least one dynamic orientation parameter comprises a speed of the agricultural machine, and the capture of the at least one analysis image is scheduled according to the speed.

In a further implementation form of the first, second, and third aspects, further comprising code for generating instructions for adjusting a position adjustment mechanism to a target location according to the at least one dynamic orientation parameter, wherein the capture of the at least one analysis image is after the adjusting the position adjustment mechanism.

In a further implementation form of the first, second, and third aspects, a same first imaging sensor and the second imaging sensor capture the first image, the second image, and the at least one analysis image, and a same processor analyzes the overlap region to compute the at least one dynamic parameter and analyzes the at least one analysis image to determine the structure depicted therein.

In a further implementation form of the first, second, and third aspects, the at least one analysis image is the first image or the second image.

In a further implementation form of the first, second, and third aspects, the at least one analysis image is in addition to the first image and to the second image.

In a further implementation form of the first, second, and third aspects, the at least one dynamic orientation parameter comprises a height of the first imaging sensor and/or second imaging sensor above the portion of the field, and further comprising code for normalizing the at least one analysis image according to the height to generate at least one normalized analysis images, wherein analyzing comprises analyzing the at least one normalized analysis image to determine the structure depicted therein.

In a further implementation form of the first, second, and third aspects, normalizing comprises normalizing a resolution of the at least one analysis image according to the height and according to a target resolution of a computational process that analyzes the at least one normalized analysis image at the target resolution for determining the structure depicted therein.

In a further implementation form of the first, second, and third aspects, further comprising selecting the target treatment profile according to the structured depicted in the at least one analysis image and according to the at least one dynamic orientation parameter.

In a further implementation form of the first, second, and third aspects, the agricultural machine is connected to a spray boom, wherein the at least one treatment application element and the first imaging sensor and the second imaging sensor are connected to the spray boom.

In a further implementation form of the first, second, and third aspects, the at least one dynamic orientation parameter comprises an amount of movement of the boom relative to a target location of the boom, wherein the at least one hardware component comprises a boom position adjustment mechanism, and wherein the instructions are for adjusting the boom position adjustment mechanism from an amount of movement to a target location from which treatment applied by the at least one treatment application element provides the target treatment profile.

In a further implementation form of the first, second, and third aspects, the at least one dynamic orientation parameter comprises an amount of vertical movement of the agricultural machine relative to a target vertical location.

In a further implementation form of the first, second, and third aspects, the at least one hardware component comprises a vertical adjustment mechanism, and wherein the instructions are for adjusting the vertical adjustment mechanism from the amount of vertical movement to a target vertical location from which treatment applied by the at least one treatment application element provides the target treatment profile.

In a further implementation form of the first, second, and third aspects, the at least one dynamic orientation parameter comprises an amount of horizontal movement of the agricultural machine relative to a target horizontal.

In a further implementation form of the first, second, and third aspects, the at least one hardware component comprises a horizontal adjustment mechanism, and wherein the instructions are for adjusting the horizontal adjustment mechanism from the amount of horizontal movement to the target horizontal location from which treatment applied by the at least one treatment application element provides the target treatment profile.

In a further implementation form of the first, second, and third aspects, the at least one hardware component comprises a spray controller of the at least one treatment application element, and the instructions are for execution by the spray controller for generating a target spray pattern to obtain the target treatment profile applied to the portion of the agricultural field.

In a further implementation form of the first, second, and third aspects, the target spray pattern comprises at least one of: (i) a target spray pattern of a sufficiently even spraying of the portion of the agricultural field, and (ii) a spot spray of the portion of the agricultural field, and no spraying of a region exterior to the portion of the agricultural field.

In a further implementation form of the first, second, and third aspects, the at least one dynamic orientation parameter comprises a speed of the agricultural machine, and the spray controller controls at least member of a group consisting of: pressure of the applied spray, duty cycle of opening/closing of each at least one spray application element, for at least one of: (i) obtaining the even spraying of the field, and (ii) synchronizing the spraying for obtaining the spot spray.

In a further implementation form of the first, second, and third aspects, the at least one dynamic orientation parameter comprises a height of the at least one treatment application element above the portion of the field.

In a further implementation form of the first, second, and third aspects, the at least one hardware component comprises a treatment controller of the at least one treatment application element, wherein the instructions are for execution by the treatment controller for dynamically adapting the treating according to the height to apply the target treatment profile.

In a further implementation form of the first, second, and third aspects, a default treatment pattern is selected for application to the portion of the agricultural by the at least one treatment application element when the height is outside of a target height range.

In a further implementation form of the first, second, and third aspects, the at least one dynamic orientation parameter comprises a speed of the at least one treatment application element relative to the portion of the field.

In a further implementation form of the first, second, and third aspects, the at least one hardware component comprises a treatment controller of the at least one treatment application element, wherein the instructions are for execution by the treatment controller for dynamically adapting the treatment controller according to the speed to apply the target treatment pattern.

In a further implementation form of the first, second, and third aspects, analyzing the overlap region to compute at least one dynamic orientation parameter of the agricultural machine comprises analyzing a percentage overlap and/or a number of overlapping pixels of the first image and the second image.

In a further implementation form of the first, second, and third aspects, the first image and second image are simultaneously captured.

In a further implementation form of the first, second, and third aspects, computing at least one dynamic orientation parameter of the agricultural machine comprises computing a height of the agricultural machine based on the percentage overlap and/or number of overlapping pixels of the first and second images that are simultaneously captured.

In a further implementation form of the first, second, and third aspects, the at least one dynamic orientation parameter comprises a height above the agricultural field, the analyzing the overlap region to compute the at least one dynamic orientation parameter of the agricultural machine comprises computing the height based on a triangulation including a first angle of the first image sensor, a second angle of the second image sensor, and the overlap region.

In a further implementation form of the first, second, and third aspects, the first imaging sensor and the second imaging sensor are a same single sensor that captures the first image and the second image at a selected time interval, wherein the at least one dynamic orientation parameter comprises a speed of the at least one treatment application element relative to the portion of the field, the speed computed based on the selected time interval between the first image and second image and the amount of the overlap region between the first image and second image denoting a distance shift of the second image relative to the first image.

In a further implementation form of the first, second, and third aspects, a plurality of sets are located on the agricultural machine, each set including two imaging sensors and a processor, and wherein the receiving, the analyzing, and the generating instructions are independently iterated and executed for each set.

In a further implementation form of the first, second, and third aspects, the at least one treatment application element applies the treatment selected from the group consisting of: gas, electrical treatment, mechanical treatment, thermal treatment, steam treatment, and laser treatment.

In a further implementation form of the first, second, and third aspects, further comprising code for: collecting, for each respective portion of a plurality of portions of the agricultural field, the dynamically adapted treatment applied to the respective portion, and generating a map of the agricultural field, indicating for each respective portion of the plurality of portions of the agricultural field, whether the target treatment profile was met indicative of properly applied treatment or not met indicative of improperly applied treatment.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic of a block diagram of a system for dynamic adaptation of a treatment applied to an agricultural field, in accordance with some embodiments of the present invention;

FIG. 2 is an exemplary arrangement of an imaging and treatment arrangement, in accordance with some embodiments of the present invention;

FIG. 3 is a flowchart of a method for dynamic adaptation of a treatment applied to an agricultural field, in accordance with some embodiments of the present invention;

FIG. 4 is a schematic of a spray boom experiencing vertical (sway) movement and/or horizontal (yaw) movement, which are measured and/or in response to which instructions are dynamically generated for obtaining the target treatment profile, in accordance with some embodiments of the present invention;

FIG. 5 is a flowchart of another method for dynamic adaptation of a treatment applied to an agricultural field, in accordance with some embodiments of the present invention; and

FIG. 6 is a schematic depicting an agricultural machine with spray boom that is selectively applying spot spraying to crops, in accordance with some embodiments of the present invention.

### DETAILED DESCRIPTION

The present invention, in some embodiments thereof, relates to agricultural treatment of plants, more specifically, but not exclusively, to systems and methods for real-time dynamic adjustment of treatment of plants.

As used herein, the term spray boom is a not necessarily limiting example of an agricultural machine. For example, the agricultural machine may not necessarily include a boom. The terms spray boom and agricultural machine may sometimes be interchanged. Other types of booms may be used for treatment, where spray boom is a not necessarily limiting example.

As used herein, the term agricultural machine and boom may sometimes be interchanged. The term agricultural machine may be sometimes interchanged with the term agricultural vehicle. The agricultural machine traverses over the agricultural field where crops are being grown for applying treatment to different portions of the field. Examples of agricultural machines include: a tractor, a drone, an airplane, an off-road vehicle, and a motor connected to a boom.

As used herein, the term spray application element is a not necessarily limiting example of a treatment application element. The terms spray application element and treatment application element may sometimes be interchanged. Spray is one example of possible treatments applied by the treatment application element. Other examples of treatments applied by the treatment application element include gas, electrical treatment, mechanical treatment (e.g., cutting at a certain height, trimming the plant, and the like), thermal treatment, steam treatment, and laser treatment.

An aspect of some embodiments of the present invention relates to systems, an apparatus, methods, and/or code instructions (e.g., stored on a memory and executable by one or more hardware processors) for dynamic adaptation and/or scheduling (i.e., in real time, or near real time) of treatment applied to a plant, for example, adjustment of a sprayer to apply a target spray profile to each of multiple portion of an agricultural field including for example, a crop and/or weeds and/or the ground. The dynamically adjusted treatment to the portion of the agricultural field may provide real time accurate treatment to each respective portion of the ground, reducing the amount of treatment sprayed on the respective field portion and/or achieving a target spray pattern (e.g., even spraying across multiple field portions) while achieving a desired target effect (e.g., fertilizer, herbicide, pesticide, water, fungicide, insecticide, growth regulator).

Multiple sets of pairs of image sensors, each pair associated with one or more spray application elements are located along a length of an agricultural machine, optionally along a spray boom. Each pair of image sensors is positioned to capture images of a portion of the agricultural field and to capture pairs of images that overlap at an overlap region. The overlap region is analyzed, and one or more dynamic orientation parameters of the agricultural machine (e.g., spray boom and/or other components) are computed, for example, an amount of vertical movement of the agricultural machine (e.g., spray boom and/or other components) relative to a target vertical location of the agricultural machine (e.g., spray boom and/or other components), an amount of horizontal movement of the agricultural machine (e.g., spray boom and/or other components) relative to a target horizontal location of the agricultural machine (e.g., spray boom and/or other components), a height of the spray application element above the portion of the field, and speed of the at least one spray application element relative to the portion of the field. According to the at least one dynamic orientation parameter, instructions (e.g., code, electrical signals) are generated for adapting hardware component(s) associated with the agricultural machine (e.g., spray boom and/or other components) for dynamic adaptation and/or scheduling of the treatment applied by the spray application element(s) to the portion of the agricultural field depicted in the first and second images, for example, to obtain a target spray profile applied to the portion of the agricultural field. In at least some implementations, the real-time analysis of the overlap region provides an indication of the vector orientation and/or direction of motion and/or speed of motion of the spray application element(s) relative to the ground portion, enabling real-time adjustment of the applied treatment sprayed onto the ground portion to obtain a target treatment profile, e.g., target spray pattern.

At least some implementations of the systems, methods, apparatus, and/or code instructions described herein address the technical problem of improving application of a treatment to an agricultural field by sprayers located on a spray boom. At least some implementations of the systems, methods, apparatus, and/or code instructions described herein improve the technical field of agricultural treatment. The treatment may be, for example, one or more of: herbicide, pesticide, and/or fertilizer. Since spray booms are very large (e.g., about 10-50 meters, or larger), they are prone to variations in location along their lengths, i.e., sprayers are not located at the same height and/or same angle along a straight line that moves along at a common speed for all sprayers, which leads to difficulty in obtaining a desired target spray pattern by the multiple sprayers located along the length of the spray boom. In one example, the technical problem relates to improving evenness on the ground of spray application from the field crop sprayers located on the boom. Even spraying helps to reduce the chemical doses applied to the agricultural field while maintaining the required biological effect. An even spray liquid distribution is obtained when the spray boom remains stable. Vertical (“sway”) movements of the boom affect the deposit density both along and across the vehicle's tracks, due to the changing spread of the spray with changing the height. Variations in the horizontal component of the velocity of the boom (“yaw”) cause fluctuations in the deposit density along the track.

At least some implementations of the systems, methods, apparatus, and/or code instructions described herein address the technical problem of measuring the yaw and/or sway movement and/or speed and/or height of the sprayer with respect to the target portion of the agricultural field to be sprayed. The (e.g., exact) measurement of the yaw and/or sway movement along the boom is particularly important for spot spraying, and/or may be relevant to even spraying. In an example, when the boom is too high or too low the image sensor may be unable to correctly identify the target plant to spray, resulting in missing the spaying for that target plant. In another example, when the boom section with the image sensor moves faster or slower than expected (e.g., relative to the vehicle to which the boom is attached), then the speed should be considered when deciding what will be the exact moment to open and to close the relevant spraying valves in order to accurately hit the target plant.

At least some implementations of the systems, methods, apparatus, and/or code instructions described herein address the above mentioned technical problem(s), and/or improve the above mentioned technical fields, and/or improve over other approaches, by using images acquired by each one of multiple arrangements on the spray boom, where each arrangement includes two image sensors associated with a sprayer. The image sensors are positioned to capture images overlapping at a portion of the field located in front of the sprayer along a predicted direction of motion of the boom (i.e., when connected to a vehicle). The sprayer is directed to spray the portion of the field captured in the first and/or second images. The overlapping region of the first and second images is analyzed to determine how the sprayer and/or the boom is to be adjusted in order to apply a target spray pattern to the field, which may depict a growth, such as a crop and/or weed and/or ground with seeds therein. The overlapping images are analyzed to identify, for example, the horizontal yaw movement, and/or the vertical sway movement, which may be corrected, for example, to improve evenness of the spraying. The overlapping images are analyzed to identify, for example, the height and/or speed of the sprayer, which may be used to control the sprayer taking into account the height and/or speed to spray the field so that a target spray pattern is applied, for example, to spray a growth and not to spray ground without growth. Each sprayer may be independently controlled and/or adjusted based on the images acquired by its associated image sensors, improving the overall spraying process. Moreover, the images acquired by the images may be analyzed to determine when to apply the spray that is delivered by the adjusted sprayer, for example, to identify weeds and spray the weeds by adjusting the sprayer according to the height and/or speed and/or horizontal movement and/or vertical movement. Furthermore, the measured height, speed, horizontal movement and/or vertical movement may be highly accurate, in particular when the image sensors are high resolution image sensors, and the overlap is accurately determined, for example, per pixel. The high resolution pixels provide the highly accurate measurements.

At least some implementations of the systems, methods, apparatus, and/or code instructions described herein address the technical problem of improving accuracy of determining a structure, optionally a biological structure, optionally a growth and/or a plant (e.g., agricultural crop, type of crop, weed, crop diseased (e.g., fungus, bacteria, virus), presence of insects on crop (e.g., infestation, biological insecticide), crop lacking water, crop receiving sufficient water, crop lacking fertilizer, crop having sufficient fertilizer, and the like) depicted in an image captured by an imaging sensor on a moving agricultural machine (e.g., boom pulled by a tractor). Due to the motion of the agricultural machine, images of plants captured by imaging sensor located on the machine may result in low accuracy of determining the state of the plant depicted in the machine, for example, captured image does not contain the plant, or contains a portion of the plant, and/or errors in classification (e.g., small plant is incorrectly identified as a large plant). At least some implementations of the systems, methods, apparatus, and/or code instructions described herein improve the technology of machine learning methods (e.g., neural network) and/or other automated methods for analysis of images to determine a state of a plant depicted in the images. For example, the dynamic orientation parameter(s) (computed from the overlap of images captured by imaging sensors on the moving vehicle) is used to schedule the capture of the image(s) used to identify the state of the plant. For example, the faster the vehicle is moving, the faster the rate of capture of images. The rate of capture of the images may be based on the speed of the vehicle and the known spacing of the plants to capture each plant once without missing plant and/or double imaging the plant. In another example, the dynamic orientation parameter(s) are used to process the images of the plants to improve accuracy of classification (e.g., by a neural network). For example, the height is used to normalize the images depicting the plants. The normalized images are inputted into the classifier (e.g., neural network). The normalization may improve accuracy of classification, for example, by setting the resolution and/or size of the image according to the training of the neural network. The size of the plant in the image may be used for classification of the plant, for example, to reduce errors in differentiating between small weeds and large crops, which may appear similar when no size normalization is performed. The same image sensors that capture the images with overlap region and the same processor that computes the dynamic orientation parameter may be used for capturing analysis images and computing the state of the plant. Using the same processors enables adding additional functionality to existing computational hardware already installed.

At least some implementations of the systems, methods, apparatus, and/or code instructions described herein improve over other approaches.

For example, in one approach, a single camera is aimed forward of the boom sprayer. The camera collects information associated with the dimensions and location of oncoming structures, such as crops, hills, fences and the like, and relays the information to a controller. The controller uses various actuators to lift, tilt and/or pivot the boom assembly to position the boom assembly at a desired height when the boom assembly passes over the structures. In contrast, at least some implementations of the systems, methods, apparatus, and/or code instructions described herein analyze an overlap of two images to compute one or more of: speed, height, horizontal movement, and vertical movement.

In another example, another approach measures the boom height using ultrasound sensors. In contrast, at least some implementations of the systems, methods, apparatus, and/or code instructions described herein analyze an overlap of two images to compute one or more of: speed, height, horizontal movement, and vertical movement.

In another example, another approach measures the boom speed using GPS, and/or encoders on the wheels a vehicle pulling the boom. In contrast, at least some implementations of the systems, methods, apparatus, and/or code instructions described herein analyze an overlap of two images to compute one or more of: speed, height, horizontal movement, and vertical movement.

In another example, another approach uses gyroscopes and/or simulates the boom according to the gyroscope measurements. In contrast, at least some implementations of the systems, methods, apparatus, and/or code instructions described herein analyze an overlap of two images to compute one or more of: speed, height, horizontal movement, and vertical movement.

In another example, conventional systems for treating crops in a field broadly apply treatment to all plants in the field, or to entire zones of plants within a field. For example, a plant treatment system can use a sprayer that evenly treats all plants in a field or zone with the same treatment without individualized plant consideration. These systems have significant drawbacks. One major drawback in the case of a spray type treatment is that treatment fluid is traditionally liberally applied throughout the zone or field, resulting in significant waste. Particularly for fertilizer treatments, the excess treatment of a nitrogen-containing fertilizer is harmful to environment in aggregate. Further, in such systems, crops and weeds are treated with fertilizers or other treatments equally, unless separate effort is expended to remove weeds before treatment. Such manual effort is expensive and time consuming, and does not necessarily result in the removal of all weeds. To achieve precision application of plant treatment, farmers may manually apply treatment to plants. However, these methods are exceptionally labor-intensive and therefore costly, particularly for any form of modern farming performed at scale. Systems that automatically detect the plant in real time, for example, differentiate between weeds and crops, and/or determine the type of crop still stuff from variations in height, speed, and/or yaw of the boom, as described herein. In contrast, at least some implementations of the systems, methods, apparatus, and/or code instructions described herein improve application of treatment to the identified plants based on the height, speed, and/or yaw of the boom, computed from captured images, as described herein.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

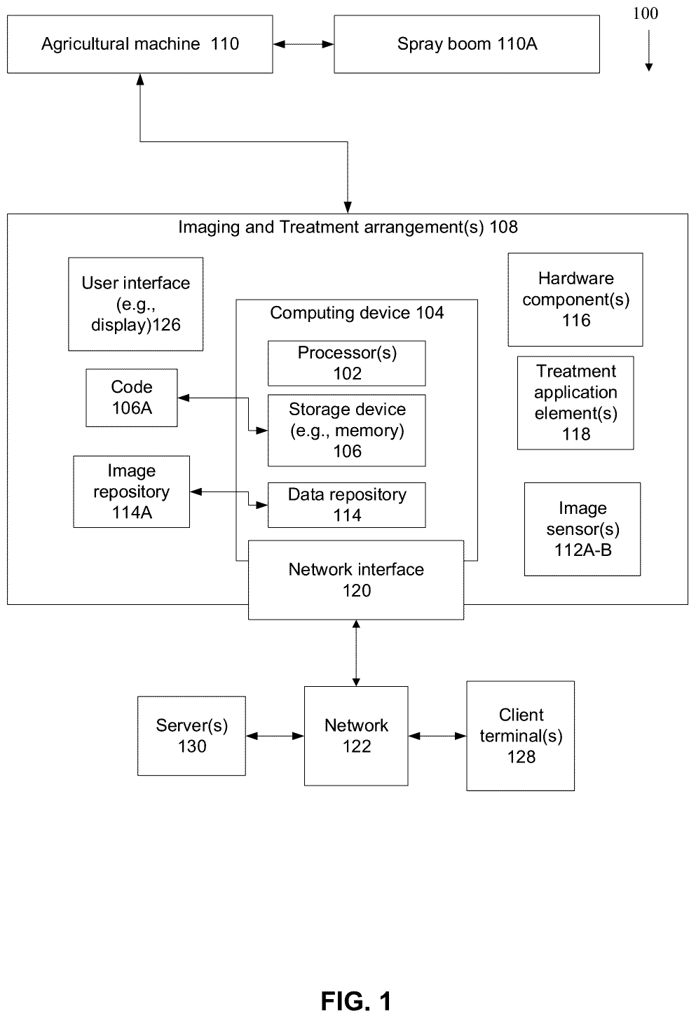

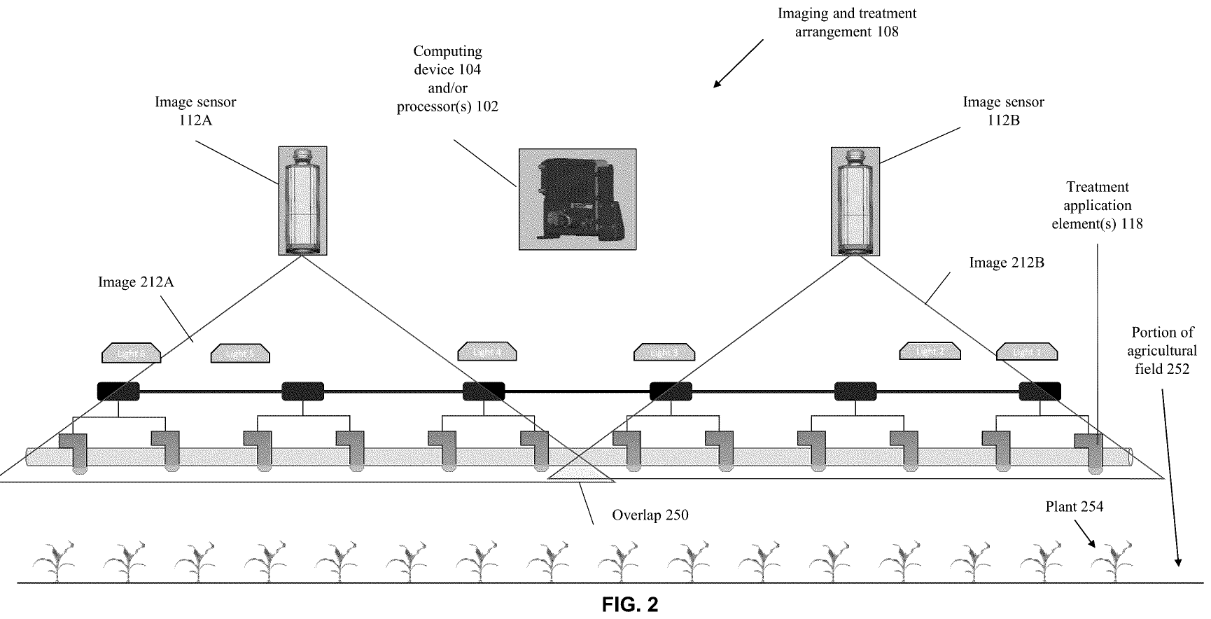

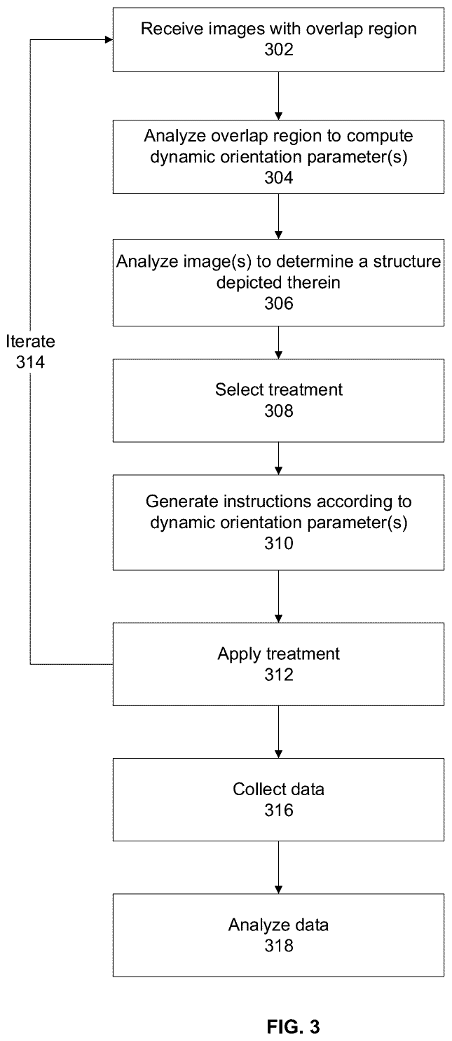

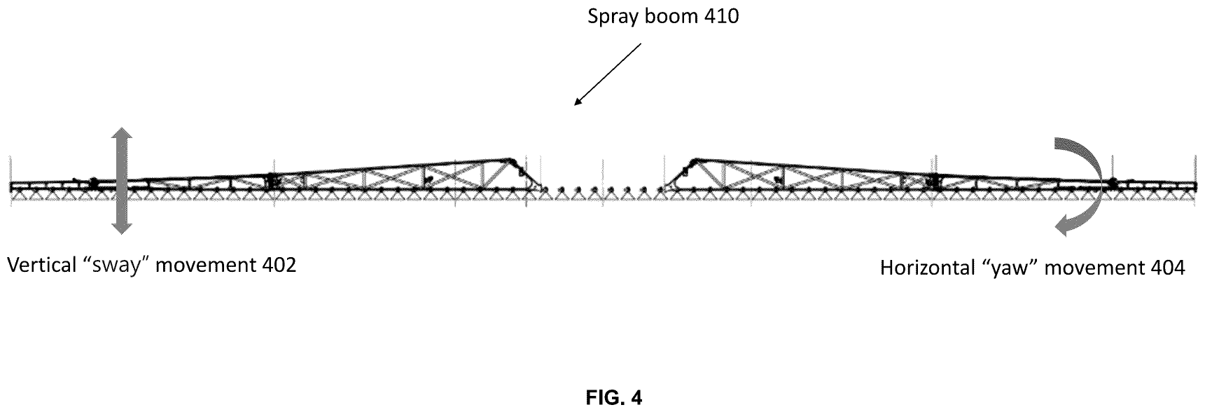

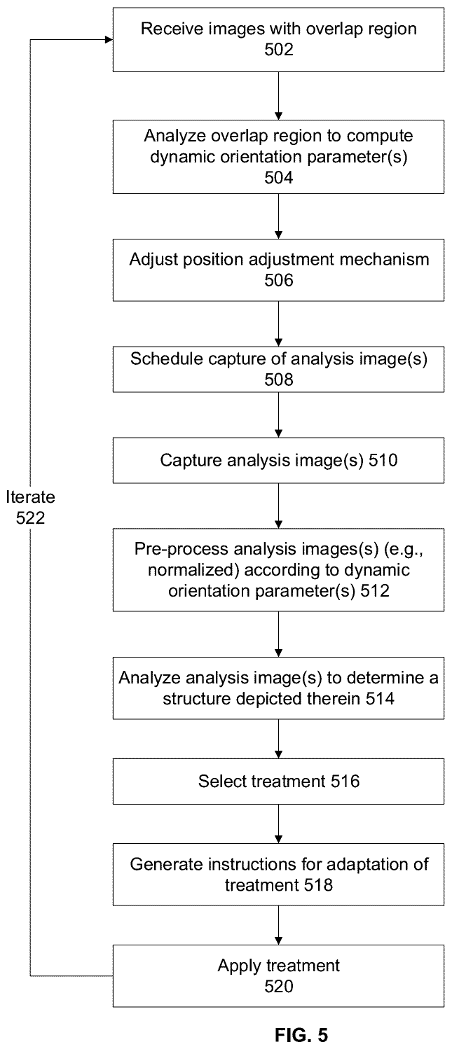

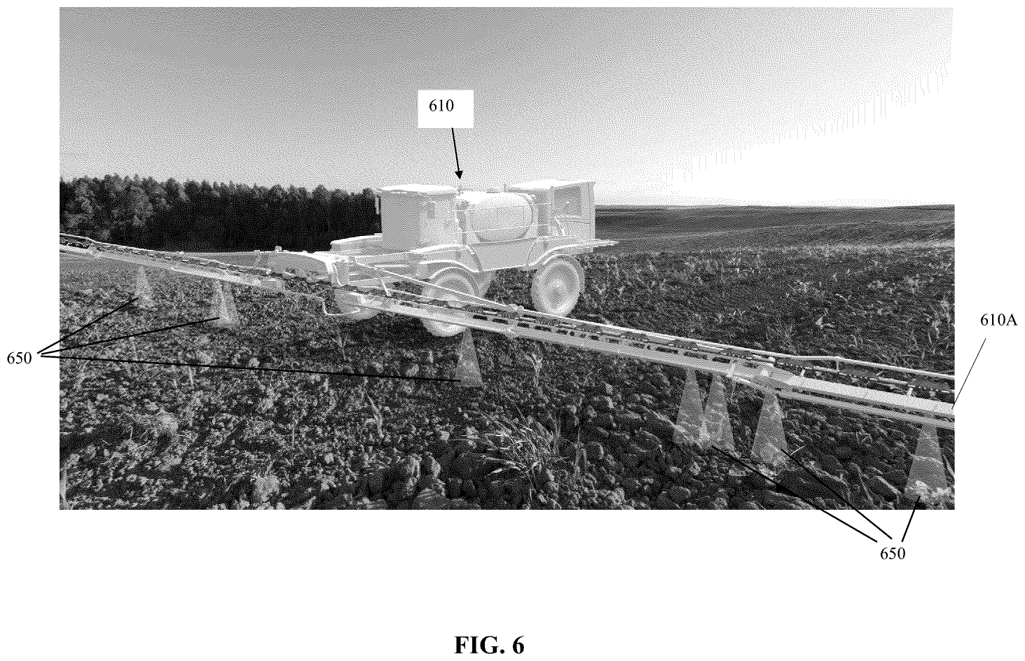

Reference is now made to FIG. 1, which is a schematic of a block diagram of a system 100 for dynamic adaptation of a treatment applied to an agricultural field, in accordance with some embodiments of the present invention. Reference is also made to FIG. 2, which is an exemplary arrangement of an imaging and treatment arrangement, in accordance with some embodiments of the present invention. Reference is also made to FIG. 3, which is a flowchart of a method for dynamic adaptation of a treatment applied to an agricultural field, in accordance with some embodiments of the present invention. Reference is also made to FIG. 4, which is a schematic of an exemplary boom, in accordance with some embodiments of the present invention. Reference is also made to FIG. 5, which is a flowchart of another method for dynamic adaptation of a treatment applied to an agricultural field, in accordance with some embodiments of the present invention. Reference is also made to FIG. 6, which is a schematic depicting an agricultural machine 610 with spray boom 610A on which are installed multiple sets of imaging and treatment arrangement(s) 108 that is selectively applying spot spraying 650 to crops, in accordance with some embodiments of the present invention. System 100 may implement the features of the method described with reference to FIG. 3 and/or FIG. 5, by one or more hardware processors 102 of a computing device 104 executing code instructions 106A stored in a memory (also referred to as a program store) 106.

System 100 includes one or more imaging and treatment arrangements 108 connected to an agricultural machine 110, for example, a tractor, an airplane, an off-road vehicle, and a drone. Agricultural machine may include and/or be connected to a spray boom 110A and/or other types of booms. As used herein, the term spray boom is used as a not necessarily limiting example, and may be substituted for other types of booms. Imaging and treatment arrangements 108 may be arranged along a length of agricultural machine 110 and/or spray boom 110A. For example, evenly spaced apart every 2-4 meters along the length of spray boom 110A. Boom 110A may be long, for example, 10-50 meters, or other lengths. Boom 110A may be pulled along by agricultural machine 110.

One imaging and treatment arrangement 108 is depicted for clarity, but it is to be understood that system 100 may include multiple imaging and treatment arrangements 108 as described herein. It is noted that each imaging and treatment arrangement 108 may include all components described herein. Alternatively, one or more imaging and treatment arrangements 108 share one or more components, for example, multiple imaging and treatment arrangements 108 share a common computing device 104 and common processor(s) 102.

Each imaging and treatment arrangement 108 includes a pair of image sensors 112A-B, for example, a color sensor, optionally a visible light based sensor, for example, a red-green-blue (RGB) sensor such as CCD and/or CMOS sensors, and/or other cameras such as infra-red (IR), near infrared, ultraviolet, and/or multispectral. Image sensors 112A-B are arranged and/or positioned to capture images of a portion of the agricultural field (e.g., located in front of image sensors 112A-B and along a direction of motion of agricultural machine 110) and to capture pairs of images that overlap at an overlap region. It is noted that in some implementations, a single image sensor 112A may be used, for example, for computing speed by using the same image sensor to capture time spaced images.

A computing device 104 receives the pairs of images from image sensors 112A-B, for example, via a direct connection (e.g., local bus and/or cable connection and/or short range wireless connection), a wireless connection and/or via a network. The pairs of images are processed by processor(s) 102, and/or may be stored in an image repository 114A of a data storage device associated with computing device 104.

Hardware processor(s) 102 of computing device 104 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 102 may include a single processor, or multiple processors (homogenous or heterogeneous) arranged for parallel processing, as clusters and/or as one or more multi core processing devices.

Storage device (e.g., memory) 106 stores code instructions executable by hardware processor(s) 102, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Memory 106 stores code 106A that implements one or more features and/or acts of the method described with reference to FIG. 2 when executed by hardware processor(s) 102.

Computing device 104 may include data repository (e.g., storage device(s)) 114 for storing data, for example, image repository 114A. Data storage device(s) 114 may be implemented as, for example, a memory, a local hard-drive, virtual storage, a removable storage unit, an optical disk, a storage device, and/or as a remote server and/or computing cloud (e.g., accessed using a network connection).

Computing device 104 is in communication with one or more hardware components 116 and/or treatment application elements 118 that apply treatment for treating the field and/or plants growing on the field, for example, spray application elements that apply a spray, gas application elements that apply a gas, electrical treatment application elements that apply an electrical pattern (e.g., electrodes to apply an electrical current), mechanical treatment application elements that apply a mechanical treatment (e.g., sheers and/or cutting tools and/or high pressure-water jets for pruning crops and/or removing weeds), thermal treatment application elements that apply a thermal treatment, steam treatment application elements that apply a steam treatment, and laser treatment application elements that apply a laser treatment.

Exemplary hardware component(s) 116 include one or more of: processor(s) 102 of computing device 104 that controls the timing of capture of images by the image sensors and/or processes the images captured by the image sensors, the image sensor(s) (e.g., for adjusting the rate of capture of images), a position adjustment mechanism for adjustment of position of the boom and/or agricultural machine and/or other component (e.g., a vertical adjustment mechanism for vertical adjustment of the boom and/or agricultural machine and/or other component, a horizontal adjustment mechanism for horizontal adjustment of the boom and/or agricultural machine and/or other component), a controller of the agricultural machine to which the boom is attached (e.g., to adjust the speed of the vehicle), and/or a controller of the treatment (e.g., spray) application element that adjusts the treatment (e.g., spray) outputted by the treatment (e.g., spray) application element(s).

Hardware component(s) 116 may be in communication with treatment application elements 118. Imaging and/or treatment arrangement 108 may include hardware components 116 and/or treatment application elements 118.

Computing device 104 and/or imaging and/or treatment arrangement 108 may include a network interface 120 for connecting to a network 122, for example, one or more of, a network interface card, an antenna, a wireless interface to connect to a wireless network, a physical interface for connecting to a cable for network connectivity, a virtual interface implemented in software, network communication software providing higher layers of network connectivity, and/or other implementations.

Computing device 104 and/or imaging and/or treatment arrangement 108 may communicate with one or more client terminals (e.g., smartphones, mobile devices, laptops, smart watches, tablets, desktop computer) 128 and/or with a server(s) 130 (e.g., web server, network node, cloud server, virtual server, virtual machine) over network 122. Client terminals 128 may be used, for example, to remotely monitor imaging and treatment arrangement(s) 108 and/or to remotely change parameters thereof. Server(s) may be used, for example, to remotely collected data from multiple imaging and treatment arrangement(s) 108 optionally of different booms, for example, to prepare reports, and/or to collect data for analysis to create code 106A updates.

Network 122 may be implemented as, for example, the internet, a local area network, a virtual network, a wireless network, a cellular network, a local bus, a point to point link (e.g., wired), and/or combinations of the aforementioned.

Computing device 104 and/or imaging and/or treatment arrangement 108 includes and/or is in communication with one or more physical user interfaces 126 that include a mechanism for user interaction, for example, to enter data (e.g., define target spray profile) and/or to view data (e.g., results of when target spray profile was applied and/or when the target spray profile was not applied).

Exemplary physical user interfaces 126 include, for example, one or more of, a touchscreen, a display, gesture activation devices, a keyboard, a mouse, and voice activated software using speakers and microphone. Alternatively, client terminal 128 serves as the user interface, by communicating with computing device 104 and/or server 130 over network 122.

Referring now to FIG. 2, an imaging and treatment arrangement 108 (e.g., as described with reference to FIG. 1, is depicted. Imaging and treatment arrangement 108 includes image sensors 112A-B connected to a computing device 104 and/or processor(s) 102, and multiple spray application element(s) 118, as described with reference to FIG. 1. Image sensors 112A-B are positioned to capture respective images 212A 212B of a portion of the agricultural field 252 that overlap at an overlap region 250. As described herein, overlap region 250 may be analyzed to determine an adjustment for treatment of plant(s) 254 (e.g., crop, weed) and/or field 252 by spray application element(s) 118, such as to obtain a target treatment profile.

Referring now back to FIG. 3, the features of the method are described with reference to a single imaging and treatment arrangement, but is to be understood as being independently implemented for each imaging and treatment arrangement installed along the boom.

At 302, a pair of images is received from the pair of image sensors. The images depict a portion of the agricultural field (e.g., located in front of the spray application elements in the direction of motion of the agricultural machine and/or boom). The pair of images overlap at an overlap region.

Optionally, the pair of images are simultaneously captured. Alternatively or additionally, the first image and the second images of the pair of images are temporally spaced apart by a predefined time interval. For example, the first image is captured, and 50 milliseconds later the second image is captured. The time-spaced images may be captured by a same single sensor. The speed of the agricultural machine may be computed based on the amount of time between the capture of the first and second images, and the amount of overlap between the first and second images, representing a distance of a shift of the second image relative to the first image.

Alternatively or additionally, a third set of image(s) also referred to herein as analysis image(s) is received. Optionally a single image at a time is received from one or both of the image sensors. The analysis image(s) may be used for determining a state of a plant depicted in the images, for example, no plant, crop, weed, and/or type of crop, as described herein. The timing of capture of the analysis image(s) may be scheduled based on an analysis of the dynamic orientation parameters computed from the pair of images, as described herein.

Optionally, multiple pairs (or sequential single images) are captured, where each pair or single image(s) are used for computing different dynamic orientation parameters, for example, one respective dynamic orientation parameter per pair or single captured image. Using different images for different dynamic orientation parameters enables adjusting and/or selecting the imaging capturing parameters (e.g., rate, resolution) for improved accuracy of computation of the respective dynamic orientation parameter. For example, when height and speed are computed in different ways, the images for height may be optimized by selecting the best image capture parameters, and the images for speed may be optimized by selectin another set of image capture parameters. The different sets of image for the different dynamic orientation parameters may be captured using the same imaging sensor(s).

At 304, the overlap region is analyzed. One or more dynamic orientation parameters of the agricultural machine (e.g., boom and/or other components) are computed according to the analysis of the overlap region. The dynamic orientation parameters of the agricultural machine (e.g., spray boom and/or other components) represent the position and/or direction of motion and/or speed of the agricultural machine (e.g., spray boom and/or other components) relative to the agricultural field which is to be treated using the spray of the spray application elements.

It is noted that multiple sets of dynamic orientation parameter(s) are computed, each set for a different location along the agricultural machine (e.g., spray boom and/or other components) corresponding to the location of the image sensor(s) of the respective imaging and treatment arrangement along the agricultural machine (e.g., spray boom and/or other components).

The overlap region may be identified in each image of the pair of images, for example, pixels corresponding to the overlap region may be labelled and/or segmented. The overlap region may be identified, for example, by iteratively moving the first image with reference to the second image, and computing a correlation value between the pixels of the first and second images. The position with pixels having highest correlation between the two images represent the overlap region. In another implementation, the first image is used as a template that is matched to the second image. Where the template best matches the second image represents the overlap region. In yet another implementation, the two images are fed into a trained machine learning model that generates an outcome of the overlap region.

The overlap region may be analyzed by computing a percentage overlap for the first and/or second images, and/or a number of overlapping pixels for first image and/or the second image. The percent overlap and/or number of overlapping pixels may be compared to a defined baseline percentage overlap and/or number of overlapping pixels that defines the baseline dynamic orientation parameters of the spray boom, for example, the configured and/or initial position and/or direction of motion of the spray boom.

Alternatively or additionally, the overlap region may be analyzed by computing a shift of the overlap region along a direction of motion of the boom between the first image and second image. For example, for each image being 100 pixels in length, the first 30 pixels of the first image and the last 30 pixels of the second image may be included in the overlap region, indicating that the second image is shifted forward with respect to the first image.

Alternatively or additionally, the overlap region may be analyzed by triangulation.

Exemplary dynamic orientation parameters, and exemplary approaches for computing the respective dynamic orientation parameters are now described.
An amount of vertical movement of the agricultural machine and/or boom and/or other component relative to a target vertical location of the agricultural machine and/or boom and/or other component, also referred to as vertical sway. The vertical movement may be due to the agricultural machine and/or boom and/or other component moving up and down, which changes the size of the field of view of the field as captured by the image sensor(s) since the distance from the respective sensor(s) to the field changes. Relative to the amount of overlap (e.g., percentage and/or number of pixels) at a baseline height, when the agricultural machine and/or boom and/or other component moves up, the amount of overlap is increased since the distance from the image sensors to the field increased, and when the agricultural machine and/or boom and/or other component moves down, the amount of overlap is decreased since the distance from the image sensors to the field is decreased. The vertical sway analysis may be performed for images captured simultaneously.
An amount of horizontal movement of the agricultural machine and/or boom and/or other component relative to a target horizontal location of the agricultural machine and/or boom and/or other component, sometime also referred to as horizontal sway and/or yaw movement. The horizontal movement is due to the agricultural machine and/or boom and/or other component moving forwards and in reverse, which changes the shift of the images relative to one another the field of view of one sensor is located behind or in front of the field of view of the other sensor. Relative to an initial no shift baseline (or other known baseline shift), a forward shift of the first sensor relative to the second sensor indicates that the first sensor is located ahead of the second sensor. The horizontal sway analysis may be performed for images captured simultaneously.
Height, optionally of the spray application element(s) above the portion of the field. The height may vary even with no vertical sway, for example, due to variations in the ground, such as trenches and/or mounds that change the height of the ground relative to the boom. The height may be computed as with reference to the vertical movement. The height may be used to compute the resolution of the respective image sensors, for example, number of millimeters of field depicted per pixel of each respective image. The resolution may be used for computation of the other dynamic orientation parameters, when the overlap amount (e.g., percentage, number of pixels) is a function of the boom speed and camera resolution, the agricultural machine and/or boom and/or other component speed may be computed. The height may be used to normalize images, for example, as described with reference to 306 and/or 512. The height may be computed, for example, based on a triangulation, that includes an angle of the first image sensor, an angle of the second image, the overlap region.
Speed of the at least one spray application element relative to the portion of the field, which may correspond to the speed of the agricultural machine and/or boom and/or other component. The speed may be computed once the resolution and height are known as described above. The speed of the spray boom may be computed based on the shift of the overlap region according to the predefined time interval between capture of the first image and capture of the second image (i.e., when the first and second images are temporally spaced apart by the predefined time interval) and/or based on the resolution. The first and second images may be captured by a same image sensor.

Alternatively or additionally, the overlap region may be analyzed by feeding the images into a trained machine learning (ML) model that generates an outcome indicative of the respective dynamic orientation parameters. For example, a neural network trained on pairs of overlapping images labelled with respective dynamic orientation parameters.

Exemplary machine learning models, as described herein, may include one or more classifiers, neural networks of various architectures (e.g., fully connected, deep, encoder-decoder), support vector machines (SVM), logistic regression, k-nearest neighbor, decision trees, boosting, random forest, and the like. Machine learning models may be trained using supervised approaches and/or unsupervised approaches.

Referring now back to FIG. 4, of a spray boom 410 (e.g., as described herein) experiencing vertical (sway) movement 402 and/or horizontal (yaw) movement 404, which are measured and/or in response to which instructions are dynamically generated for obtaining the target treatment profile, is depicted.

Referring now back to FIG. 3, at 306, optionally, another image (e.g., one or more analysis images), may be analyzed to determine the presence of a structure depicted therein, optionally a biological and/or agricultural structure, optionally a plant and/or growth, for example, presence or absence of the structure in the image, location of the structure in the image, agricultural crop, type of crop (e.g., lettuce, carrot, tomato, potato, watermelon, corn, wheat), undesired plants (e.g., weed), stage of growth (e.g., flowering, small fruits/vegetables, fully grown fruits/vegetables), crop diseased (e.g., infected with fungus, bacteria, virus, protozoa, worms), presence of insects on crop (e.g., infestation, biological insecticide), crop lacking water, crop receiving sufficient water, crop lacking fertilizer, crop having sufficient fertilizer, healthy, sufficient growth, and insufficient growth.

The analysis image may be analyzed to determine a state of a plant(s) depicted therein and/or an indication of the plant depicted therein.

The analysis image may be the first and/or second image(s). Alternatively, the analysis image is in addition to the first and/or second image(s).

The analysis image(s) used to determine the state of the plant may be captured by the same image sensor(s) used to capture the image(s) used to compute the dynamic orientation parameter(s). The analysis image(s) used to determine the state of the plant may be in addition to the first and/or second images used to compute the dynamic orientation parameter(s). The processor used to analyze the images to compute the dynamic orientation parameter(s) may compute the state of the plant.

The state of the plant may be determined, for example, by a trained ML model that generates an outcome of the state of the plant, trained on a training dataset of images labelled with the state of the plant depicted therein. In another example, the state of the plant may be determined, for example, by analyzing colors of the image(s), for example, finding sets of contiguous pixels depicting green color within a brown background.

Optionally, the instructions are for execution by the processor(s) that processes images captured for determining a state of a plant depicted therein. The instructions may be for adapting operation of the processor according to the computed dynamic orientation parameter, optionally for normalizing the images captured for determining the state of the plant according to the computed height. (It is noted that the adaption of the processor(s) may be performed in association with 306 rather than and/or in addition to 310).

Optionally, when the height dynamic orientation parameter is computed (as described herein), the analysis image(s) captured for determining the state of the plant are normalized according to the height to generate normalized analysis images. The normalized analysis image(s) may be analyzed to determine the state of the plant depicted therein. For example, the normalization enables differentiating between a small weed and a large desired crop, which may appear similar for different height.

Optionally, the normalization of the analysis image(s) includes normalizing the resolution of the analysis image(s) according to the height. The resolution is normalized according to a target resolution of the computational process (e.g., neural network, ML model, classifier) that analyzes the normalized analysis image(s) at the target resolution for computing the state of the plant, for example, a neural network that receives images at the target resolution. Normalization to the target resolution may increase accuracy of the computational process. The normalization may be, for example, a resizing of images to obtain a constant pixel-per-inch (PPI) for the analysis images, for example, by down-sampling and/or up-sampling the images to decrease and/or increase the PPI.

At 308, a treatment for application to the portion of the agricultural field may be selected. The treatment may be selected according to the computed state of the plant. For example, when the plant is identified as a weed, an herbicide is selected, when the plant is identified as a desired crop a pesticide may be selected, when the plant is identified as lacking water then water may be selected, and/or when the plant is identified as insufficient growth then fertilizer may be selected. Alternatively, in some cases, no treatment is selected, for example, where no plant is present.

At 310, instructions are generated according to the dynamic orientation parameter(s). The instructions may be, for example, code and/or electrical signals, and/or other instructions for automated execution. The instructions may be for execution by hardware component(s) associated with the spray boom for dynamic adaptation of the treatment applied by the spray application element(s) to the portion of the agricultural field depicted in the first and second images to obtain a target treatment profile.

Optionally, the instructions are for execution by a treatment (e.g., spray) controller of the treatment (e.g., spray) application element(s) for generating a target treatment (e.g., spray) pattern to obtain the target treatment profile applied to the portion of the agricultural field. In an implementation, the target spray pattern may be a sufficiently even spraying of the portion field to obtain the target treatment profile of even spraying. In another implementation, the target spray pattern is a spot spray of the portion of the agricultural field (e.g., which includes a plant), where no spraying of a region exterior to the portion of the agricultural field (e.g., which does not include the plant) is performed, to obtain the target treatment profile of spot spraying of the plants. The spray controller may adjust the pressure of the applied spray and/or the duty cycle of the opening and/or closing of each sprayer, and/or synchronize when the spray is applied, for example, based on the computed speed, height, vertical sway, and/or other dynamic orientation parameters.

Optionally, when the plant is identified without a bounding region (e.g., box) of the image (e.g., the analysis image described herein), the instructions are for the treatment controller to synchronize application of the treatment by treatment application element (e.g., spray application element) within the boundary box, when the region on the ground corresponding to the boundary box is estimated to be located where the treatment application element applies the treatment. The treatment selected for the plant within the boundary region may be applied.

Optionally, when the instructions are for execution by a treatment (e.g., spray) controller, the instructions are for dynamically execution by the spray controller for adapting the treatment (e.g., spraying) according to the height and/or speed to provide the target treatment profile. For example, when the height is higher than a baseline, the spraying may be more focused to obtain a target spot spray pattern. When the height is lower than the baseline, the spraying may be directed outwards to obtain the target spot spray pattern. When the speed is faster than the baseline, the spraying may be at a faster application rate. When the speed is slower than the baseline, the spraying may be at a slower application rate. In another example, when the spray controller activates the spray application elements at a selected frequency, the frequency may be adjusted based on the speed and/or height, such as to obtain a uniform target spray pattern and/or for a spot spray target pattern. For example, at low speed of the boom, the frequency is set to a relatively low value. As the speed is increased, the frequency may be increased.

Optionally, the instructions are for execution by a position adjustment mechanism. The instructions may be for adjusting the position (e.g., vertical, height) of the agricultural machine and/or other components, optionally the boom as described herein. The instructions may be for adjusting the position adjustment mechanism to a target position from which treatment applied by the treatment (e.g., spray) application element provides the target treatment profile.

Optionally, the instructions are for execution by a position adjustment mechanism (e.g., vertical boom and/or height adjustment mechanism). The instructions may be for adjusting the vertical boom and/or height adjustment mechanism from the amount of vertical movement and/or height to a target vertical location and/or height (e.g., baseline) from which treatment applied by the spray application element provides the target treatment profile. When the boom experiences vertical sway and/or the height varies (e.g., due to ground variation such as ditches and mounds), the target treatment profile is not met since the boom moves up and/or down and/or is higher and/or lower relative to the ground. When the boom is restored to the target vertical location and/or to the desired height, the spray application element(s) provide the target treatment profile.

Optionally, the instructions are for execution by a horizontal boom adjustment mechanism. The instructions may be for adjusting the horizontal boom adjustment mechanism from the amount of horizontal movement to a target horizontal location (e.g., baseline) from which treatment applied by the spray application element provides the target treatment profile. When the boom experiences horizontal sway, the target treatment profile is not met since the boom moves forwards and/or reverse. When the boom is restored to the target horizontal location, the spray application element(s) provide the target treatment profile.

Optionally, when the height and/or resolution is outside of a target range (e.g., greater or less than about 10%, 15%, or 25% of a baseline) a default treatment pattern may be selected for application to the portion of the agricultural by the spray application elements. For example, a low resolution or large height may result in inaccurate identification of plants in the images. In another example, a high resolution or low height may result in a small area of the field being depicted within the images, where field between the image sensors is not depicted in any images. The instructions may be for the spray controller to apply the default treatment pattern.

Optionally, the instructions are for execution by the processor(s) that controls the imaging sensor(s), and/or the instructions may be for execution by the imaging sensor(s). The instructions may be for timing the capture of the image(s) by the imaging sensor(s) according to the dynamic orientation parameters. For example, the images may be captured at a faster rate and/or slower rate according to the current speed of the agricultural machine. In an exemplary implementation, when the first and second images are captured for computing the speed, rate of capture of the analysis images for determining the state of the plant may be selected according to the speed, for example, when the speed of the agricultural vehicle is increased, the rate of capture of the analysis images is increased to cover the ground appropriately. It is noted that the rate of capture of the first and second images may be adjusted according to the computed speed.

Optionally, the instructions are for execution by the processor(s) that processes images captured for determining a state of a plant depicted therein. The instructions may be for adapting operation of the processor according to the computed dynamic orientation parameter, optionally for normalizing the images captured for determining the state of the plant according to the computed height.

Optionally, the instructions are for execution by a user. For example, when the computed speed falls outside of a range (e.g., too high and/or too low), an indication may be generated for the user to manually adjust the speed of the agricultural vehicle to be within the range (e.g., slow down and/or increase speed).

At 312, the treatment is applied (e.g., sprayed) to the portion of the agricultural field by the spray application element(s), for example, to the plant(s) and/or ground.

At 314, one or more features described with reference to 302-312 are iterated. Iterations may be performed per imaging and treatment arrangement (e.g., in parallel) over time as the agricultural machine advances. The iterations may be performed quickly, in real time, for example, for spot spraying plants in real time as the boom is moved. Iterations may be at predefined time intervals, for example, every about 20-50 centimeters movement of the boom, every about 50-100 milliseconds, or other values, and/or for example, images are captured as a video, and each frame (or every few frames) are analyzed.

At 316, data may be collected. For example, stored in a server.

Data may be collected for each boom operation session, for the field as a whole, including data from multiple portions of the agricultural field. The data may include, for example, one or more of: the respective geographical location of the boom within the field, the computed overlap, the image(s), the computed dynamic orientation parameter(s), the instructions for execution by the hardware component(s), the computed dynamic adaptions of the treatment, and/or whether the target treatment profile was met or not.

Data may be collected from multiple different booms, for example, of different operators and/or in different fields.

At 318, the collected data may be analyzed.

Optionally, a map of the agricultural field is generated and/or presented. The presented map may include for each respective portion of the agricultural field, an indication of whether the target treatment profile was met indicative of properly applied treatment or not met indicative of improperly applied treatment. For example, red squares on the map indicate that the target treatment profile was not met, and green squares indicate that the target treatment profile was met.

Optionally, the data may be analyzed for improvements, for example, updating training of ML models, updating the generation of instructions to improve the rate of meeting the target treatment profile, and the like.

It is noted that features described with reference to FIG. 3 may be implemented in a different order and/or arrangement that depicted, for example, as described with reference to FIG. 5.

Referring now back to FIG. 5, features described with reference to FIG. 5 may correspond to, and/or be combined with, and/or be alternatively to, and/or be integrated with, and/or be variations of, one or more features described with reference to FIG. 3. FIG. 5 depicts an example of scheduling the capture of analysis image(s) according to the dynamic orientation parameter computed from the overlap region of other captured images, and/or treating the plant according to an analysis of the analysis image(s) and/or according to the dynamic orientation parameter.

At 502, a pair of images that overlap at an overlap region are received, for example, as described with reference to 302 of FIG. 3.

At 504, one or more dynamic orientation parameter(s) are computed according to an analysis of the overlap region, for example, as described with reference to 304 of FIG. 3.

At 506, optionally, a position adjustment mechanism is adjusted to a target location according to the dynamic orientation parameter(s). For example, the horizontal height and/or vertical sway of the boom is adjusted. Instructions may be generated for execution by the position adjustment mechanism, as described herein. Other exemplary adjustments of the position adjustment mechanism are described, for example, with reference to 310 of FIG. 3.

Alternatively, no adjustment of the position adjustment mechanism is done.

At 508, the capture of one or more analysis images is scheduled (e.g., adjusted and/or selected) according to the computed dynamic orientation parameter(s). For example, the timing of capture of the analysis image(s) and/or the rate of capture of the analysis images is selected and/or adjusted according to the dynamic orientation parameter(s).

Optionally, the rate of capture of analysis images is less than the rate of capture of the pair of images with overlap. The higher rate of capture of the images with overlap may enable real time computation of the dynamic orientation parameter(s) for real time adjustment of the rate of capture of the analysis images.

For example, when the dynamic orientation parameter is a speed of the agricultural vehicle, the capture of the analysis image is scheduled according to the speed. For example, when the speed of the agricultural vehicle is computed from the overlap of the images, and the plants are known to be spaced by 30 centimeters from one another, the rate of capture of the analysis images may be adjusted based on the speed to capture one image every 30 centimeters.

Optionally, the capture of the analysis images(s) is scheduled after the position adjustment mechanism has been adjusted. The scheduling may be performed based on the adjusted position adjustment mechanism. For example, the scheduling of the capture of the analysis image(s) is after the correction of the yaw and/or sway motion of the boom.

At 510, analysis image(s) are captured according to the selected schedule (e.g., selected timing and/or rate). The analysis image(s) may be in addition to the pairs of images that include the overlapping images. The analysis image(s) may be captured by the first imaging sensor excluding the second imaging sensor, the second imaging sensor excluding the first imaging sensor, and/or by both the first and second imaging sensors.

The same sensors used to capture the pairs of images with overlap region may be used to capture the analysis image(s).

At 512, the analysis images may be pre-processed according to the dynamic orientation parameter. The pre-processed analysis images are analyzed as described herein, for example, inputted into a trained classifier.

Optionally, the dynamic orientation parameter is a height of the imaging sensor(s) above the portion of the field. The pro-processing may include normalizing the analysis image(s) according to the height to generate normalized analysis image(s). The normalization may be normalizing a resolution of the analysis image according to the height and according to a target resolution of a computational process (e.g., classifier, other process) that analyzes the normalized analysis image at the target resolution for computing the state of the plant.

At 514, the one analysis image(s), optionally the pre-processed analysis image(s) (e.g., normalized analysis images(s)) are analyzed to determine a state of the plant depicted therein, for example, as described with reference to 306 of FIG. 3.

Optionally, the same processor that analyzes the overlap region to compute the dynamic parameter may analyze the analysis image(s) to determine the state of the plant depicted therein.

At 516, the target treatment profile may be selected according to the state of the plant and/or according to the dynamic orientation parameter. For example, for spot spraying, the amount of liquid to spray and/or the timing of the spray may be selected according to the speed of the moving spay application element (connected to the agricultural machine) and according to the identified crop within the image (e.g., weeds are not sprayed).

The treatment may be selected according to the state of the plant, for example, as described with reference to 308 of FIG. 3.

At 518, instructions are generated according to dynamic orientation parameter and/or the state of the plant and/or the target treatment profile (which is determined based on the state of the plant and/or according to the dynamic orientation parameter), for adapting hardware component(s) associated with the agricultural machine for dynamic adaptation of the treatment applied by the treatment application element to the plant depicted in the analysis image to obtain the target treatment profile, for example, as described with reference to 310 of FIG. 3.

At 520, the treatment is applied, for obtaining the target treatment profile, by executing the instructions by the hardware component, for example, as described with reference to 312 of FIG. 3.

At 522, one or more of 502-520 are iterated. Iterations may be performed per imaging and treatment arrangement (e.g., in parallel) over time as the agricultural machine advances. For example, as described with reference to 314 of FIG. 3.

It is noted that data may be collected as described with reference to 316 of FIG. 3, and/or data may be analyzed as described with reference to 318 of FIG. 3.

Referring now back to FIG. 6, agricultural machine 610 with spray boom 610A on which are installed multiple sets of imaging and treatment arrangement(s) is selectively applying spot spraying 650 to crops. Components of agricultural machine 610 may be as described with reference to system 100 of FIG. 1. The spraying may be based on the methods described with reference to FIG. 3 and/or FIG. 5. The spot spraying 650 may be selectively adjusted and/or selected according to a determination of the state of the plant depicted in captured analysis images (which may be scheduled according to the dynamic orientation parameter(s)) and/or according to the dynamic orientation parameters computed based on an overlap of captured image pairs, as described herein. Treatment for each plan may be optimized for that plant, by selecting the best treatment and/or adjusting the spray according to the identified state of the plant and/or the dynamic orientation parameters, as described herein.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant booms will be developed and the scope of the term boom is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A system for dynamic adaptation of a treatment applied to an agricultural field growing crops, comprising:
at least one hardware processor executing a code for:
receiving a first image from a first imaging sensor and a second image from a second imaging sensor, wherein the first imaging sensor and the second imaging sensor are located on an agricultural machine having at least one treatment application element that applies the treatment to the agricultural field, wherein the first image and the second image depict a portion of the agricultural field and overlap at an overlap region;
analyzing the overlap region to compute at least one dynamic orientation parameter of the agricultural machine; and
generating instructions, according to the at least one dynamic orientation parameter, for execution by at least one hardware component associated with the agricultural machine for dynamic adaptation of the treatment applied by the at least one treatment application element to the portion of the agricultural field depicted in the first and second images to obtain a target treatment profile.

2. The system of claim 1, further comprising code for:
capturing at least one analysis image depicting a structure of a portion of the agricultural field by the first imaging sensor and/or the second imaging sensor;
analyzing the at least one analysis image to determine the structure depicted therein; and
wherein generating instructions, comprises generating instructions according to the at least one dynamic orientation parameter and the structure depicted therein, for adapting at least one hardware component associated with the agricultural machine for dynamic adaptation of the treatment applied by the at least one treatment application element to the structure depicted in the at least one analysis image to obtain the target treatment profile.

3. The system of claim 2, wherein the structure determined by the analysis of the at least one analysis image is selected from a group consisting of: presence or absence of the structure in the image, location of the structure in the image, agricultural crop, type of crop, undesired plants, weeds, stage of growth, crop diseased, presence of insects on crop, crop lacking water, crop receiving sufficient water, crop lacking fertilizer, crop having sufficient fertilizer, healthy, sufficient growth, and insufficient growth.

4. The system of claim 2, further comprising code for scheduling the capture of the at least one analysis image according to the computed at least one dynamic orientation parameter.

5. The system of claim 2, wherein the at least one dynamic orientation parameter comprises a speed of the agricultural machine, and the capture of the at least one analysis image is scheduled according to the speed.

6. The system of claim 2, further comprising code for generating instructions for:
adjusting a position adjustment mechanism to a target location according to the at least one dynamic orientation parameter, wherein the capture of the at least one analysis image is after the adjusting the position adjustment mechanism.

7. The system of claim 2, wherein a same first imaging sensor and the second imaging sensor capture the first image, the second image, and the at least one analysis image, and a same processor analyzes the overlap region to compute the at least one dynamic parameter and analyzes the at least one analysis image to determine the structure depicted therein.

8. The system of claim 2, wherein the at least one analysis image is the first image or the second image.

9. The system of claim 2, wherein the at least one analysis image is in addition to the first image and to the second image.

10. The system of claim 2, wherein the at least one dynamic orientation parameter comprises a height of the first imaging sensor and/or second imaging sensor above the portion of the field, and further comprising code for normalizing the at least one analysis image according to the height to generate at least one normalized analysis images, wherein analyzing comprises analyzing the at least one normalized analysis image to determine the structure depicted therein.

11. The system of claim 10, wherein normalizing comprises normalizing a resolution of the at least one analysis image according to the height and according to a target resolution of a computational process that analyzes the at least one normalized analysis image at the target resolution for determining the structure depicted therein.

12. The system of claim 2, further comprising selecting the target treatment profile according to the structured depicted in the at least one analysis image and according to the at least one dynamic orientation parameter.

13. The system of claim 1, wherein the agricultural machine is connected to a spray boom, wherein the at least one treatment application element and the first imaging sensor and the second imaging sensor are connected to the spray boom.

14. The system of claim 13, wherein the at least one dynamic orientation parameter comprises an amount of movement of the boom relative to a target location of the boom, wherein the at least one hardware component comprises a boom position adjustment mechanism, and wherein the instructions are for adjusting the boom position adjustment mechanism from an amount of movement to a target location from which treatment applied by the at least one treatment application element provides the target treatment profile.

15. The system of claim 1, wherein the at least one dynamic orientation parameter comprises an amount of vertical movement of the agricultural machine relative to a target vertical location.

16. The system of claim 1, wherein the at least one hardware component comprises a vertical adjustment mechanism, and wherein the instructions are for adjusting the vertical adjustment mechanism from the amount of vertical movement to a target vertical location from which treatment applied by the at least one treatment application element provides the target treatment profile.

17. The system of claim 1, wherein the at least one dynamic orientation parameter comprises an amount of horizontal movement of the agricultural machine relative to a target horizontal.

18. The system of claim 17, wherein the at least one hardware component comprises a horizontal adjustment mechanism, and wherein the instructions are for adjusting the horizontal adjustment mechanism from the amount of horizontal movement to the target horizontal location from which treatment applied by the at least one treatment application element provides the target treatment profile.

19. The system of claim 1, wherein the at least one hardware component comprises a spray controller of the at least one treatment application element, and the instructions are for execution by the spray controller for generating a target spray pattern to obtain the target treatment profile applied to the portion of the agricultural field.

20. The system of claim 19, wherein the target spray pattern comprises at least one of: (i) a target spray pattern of a sufficiently even spraying of the portion of the agricultural field, and (ii) a spot spray of the portion of the agricultural field, and no spraying of a region exterior to the portion of the agricultural field.

21. The system of claim 20, wherein the wherein the at least one dynamic orientation parameter comprises a speed of the agricultural machine, and the spray controller controls at least member of a group consisting of: pressure of the applied spray, duty cycle of opening/closing of each at least one spray application element, for at least one of: (i) obtaining the even spraying of the field, and (ii) synchronizing the spraying for obtaining the spot spray.

22. The system of claim 1, wherein the at least one dynamic orientation parameter comprises a height of the at least one treatment application element above the portion of the field.

23. The system of claim 22, wherein the at least one hardware component comprises a treatment controller of the at least one treatment application element, wherein the instructions are for execution by the treatment controller for dynamically adapting the treating according to the height to apply the target treatment profile.

24. The system of claim 22, wherein a default treatment pattern is selected for application to the portion of the agricultural by the at least one treatment application element when the height is outside of a target height range.

25. The system of claim 1, wherein the at least one dynamic orientation parameter comprises a speed of the at least one treatment application element relative to the portion of the field.

26. The system of claim 25, wherein the at least one hardware component comprises a treatment controller of the at least one treatment application element, wherein the instructions are for execution by the treatment controller for dynamically adapting the treatment controller according to the speed to apply the target treatment pattern.

27. The system of claim 1, wherein analyzing the overlap region to compute at least one dynamic orientation parameter of the agricultural machine comprises analyzing a percentage overlap and/or a number of overlapping pixels of the first image and the second image.

28. The system of claim 27, wherein the first image and second image are simultaneously captured.

29. The system of claim 28, wherein computing at least one dynamic orientation parameter of the agricultural machine comprises computing a height of the agricultural machine based on the percentage overlap and/or number of overlapping pixels of the first and second images that are simultaneously captured.

30. The system of claim 1, wherein the at least one dynamic orientation parameter comprises a height above the agricultural field, the analyzing the overlap region to compute the at least one dynamic orientation parameter of the agricultural machine comprises computing the height based on a triangulation including a first angle of the first image sensor, a second angle of the second image sensor, and the overlap region.

31. The system of claim 1, wherein the first imaging sensor and the second imaging sensor are a same single sensor that captures the first image and the second image at a selected time interval, wherein the at least one dynamic orientation parameter comprises a speed of the at least one treatment application element relative to the portion of the field, the speed computed based on the selected time interval between the first image and second image and the amount of the overlap region between the first image and second image denoting a distance shift of the second image relative to the first image.

32. The system of claim 1, wherein a plurality of sets are located on the agricultural machine, each set including two imaging sensors and a processor, and wherein the receiving, the analyzing, and the generating instructions are independently iterated and executed for each set.

33. The system of claim 1, wherein the at least one treatment application element applies the treatment selected from the group consisting of: gas, electrical treatment, mechanical treatment, thermal treatment, steam treatment, and laser treatment.

34. The system of claim 1, further comprising code for:
collecting, for each respective portion of a plurality of portions of the agricultural field, the dynamically adapted treatment applied to the respective portion; and
generating a map of the agricultural field, indicating for each respective portion of the plurality of portions of the agricultural field, whether the target treatment profile was met indicative of properly applied treatment or not met indicative of improperly applied treatment.

35. A computer implemented method of dynamic adaptation of a treatment applied to an agricultural field, comprising:
receiving a first image from a first imaging sensor and a second image from a second imaging sensor, wherein the first imaging sensor and the second imaging sensor are located on an agricultural machine having at least one treatment application element that applies the treatment to the agricultural field, wherein the first image and the second image depict a portion of the agricultural field and overlap at an overlap region;
analyzing the overlap region to compute at least one dynamic orientation parameter of the agricultural machine; and
generating instructions, according to the at least one dynamic orientation parameter, for execution by at least one hardware component associated with the agricultural machine for dynamic adaptation of the treatment applied by the at least one treatment application element to the portion of the agricultural field depicted in the first and second images to obtain a target treatment profile.

36. A computer program product for dynamic adaptation of a treatment applied to an agricultural field comprising program instructions which, when executed by a processor, cause the processor to perform:
receiving a first image from a first imaging sensor and a second image from a second imaging sensor, wherein the first imaging sensor and the second imaging sensor are located on an agricultural machine having at least one treatment application element that applies the treatment to the agricultural field, wherein the first image and the second image depict a portion of the agricultural field and overlap at an overlap region;
analyzing the overlap region to compute at least one dynamic orientation parameter of the agricultural machine; and
generating instructions, according to the at least one dynamic orientation parameter, for execution by at least one hardware component associated with the agricultural machine for dynamic adaptation of the treatment applied by the at least one treatment application element to the portion of the agricultural field depicted in the first and second images to obtain a target treatment profile.
